(19) United States
(12) Patent Application Publication
(10) Pub. No.: US 2024/0359456 A1
(43) Pub. Date: Oct. 31, 2024

(54) IMAGE FORMING APPARATUS

(71) Applicant: KYOCERA Document Solutions Inc., Osaka (JP)

(72) Inventors: Jun Nakano, Osaka (JP); Hiroomi Nakatsuji, Osaka (JP); Naoko Kawashima, Osaka (JP); Masato Usui, Osaka (JP)

(21) Appl. No.: 18/641,309

(22) Filed: Apr. 19, 2024

(30) Foreign Application Priority Data
Apr. 27, 2023 (JP) 2023-072940

(51) Int. Cl. B41J 2/045

(52) U.S. Cl. CPC B41J 2/04508; B41J 2/0451

(57) ABSTRACT

A recording head ejects ink using nozzles. A control unit determines nozzles corresponding to an image to be printed and causes the recording head to eject ink from the nozzles. A correction processing unit detects an ejection malfunction nozzle and performs a correction process corresponding to the ejection malfunction nozzles. The correction processing unit causes a secondary adjacent nozzle of the ejection malfunction nozzle to perform ink ejection with a first ink ejection amount if ink ejection of a primary adjacent nozzle of ejection malfunction nozzle is performed earlier than ink ejection of the secondary adjacent nozzle and causes the secondary adjacent nozzle to perform ink ejection with a second ink ejection amount if ink ejection of the primary adjacent nozzle is performed later than ink ejection of the secondary adjacent nozzle. Here, the second ink ejection amount is smaller than the first ink ejection amount.

### CROSS-REFERENCE TO RELATED APPLICATIONS

This application relates to and claims priority rights from Japanese Patent Application No. 2023-072940, filed on Apr. 27, 2023, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus (a) detects an ejection malfunction nozzle, that is a nozzle that does not properly eject ink among nozzles that eject ink in a recording head, (b) if a primary adjacent nozzle ejects ink later than a secondary adjacent nozzle where the primary adjacent nozzle ejects an ink droplet at a dot position adjacent to a dot position that the ejection malfunction nozzle should eject an ink droplet at and the secondary adjacent nozzle that ejects an ink droplet at a dot position adjacent to a dot position that the primary adjacent nozzle should eject an ink droplet at, (b1) increases an ink ejection amount (ink droplet amount) of the primary adjacent nozzle, (b2) cancels ink ejection (ink droplet) of the secondary adjacent nozzle and (b3) increases an ink ejection amount (ink droplet amount) of a tertiary adjacent nozzle where the tertiary adjacent nozzle ejects an ink droplet at a dot position adjacent to a dot position that the secondary adjacent nozzle should eject an ink droplet at, and thereby controls movement of an ink droplet ejected from the primary adjacent nozzle (the movement due to ink droplet coalescence).

In the aforementioned image forming apparatus, an ink ejection amount of the tertiary adjacent nozzle is adjusted in order to restrain influence (density decrease) due to canceling ink ejection (ink droplet) of the secondary adjacent nozzle, but when the tertiary adjacent nozzle does not eject ink (i.e. when the tertiary adjacent nozzle is not required to eject ink), the adjustment of the ink ejection amounts may affect image quality.

### SUMMARY

An image forming apparatus according to an aspect of the present disclosure includes a recording head, a control unit, and a correction processing unit. The recording head is configured to eject ink corresponding to an image to be printed, using nozzles. The control unit is configured to determine nozzles corresponding to the image to be printed, correspondingly to a position of a print sheet, and cause the recording head to eject ink from the nozzles. The correction processing unit is configured to detect an ejection malfunction nozzle and perform a correction process corresponding to the ejection malfunction nozzles. Further, when a nozzle that ejects an ink droplet at a dot position adjacent to a dot position that the ejection malfunction nozzle should eject an ink droplet at is referred to as a primary adjacent nozzle and a nozzle that ejects an ink droplet at a dot position adjacent to a dot position that the primary adjacent nozzle should eject an ink droplet at is referred to as a secondary adjacent nozzle, the correction processing unit (a) causes the secondary adjacent nozzle to perform ink ejection with a first ink ejection amount if ink ejection of the primary adjacent nozzle is performed earlier than ink ejection of the secondary adjacent nozzle and (b) causes the secondary adjacent nozzle to perform ink ejection with a second ink ejection amount if ink ejection of the primary adjacent nozzle is performed later than ink ejection of the secondary adjacent nozzle. Here, the second ink ejection amount is smaller than the first ink ejection amount.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a diagram that explains nozzles in the recording heads 1a to 1d shown in FIG. 2;

FIG. 4 shows a block diagram that indicates an electronic configuration of the image forming apparatus 10 in the embodiment according to the present disclosure;

FIG. 5 shows a diagram that explains a primary adjacent nozzle and a secondary adjacent nozzle if an ejection malfunction nozzle is an early ejection nozzle;

FIG. 6 shows a diagram that explains a primary adjacent nozzle and a secondary adjacent nozzle if an ejection malfunction nozzle is a late ejection nozzle;

FIG. 7 shows a diagram that explains an ink ejection amount of a secondary adjacent nozzle in case of non ejection;

FIG. 8 shows a diagram that explains an ink ejection amount of a secondary adjacent nozzle in case of ejection deviation;

FIG. 9 shows a diagram that explains an ink ejection amount of a primary adjacent nozzle in case of non ejection;

FIG. 10 shows a diagram that explains an ink ejection amount of a primary adjacent nozzle in case of ejection deviation; and

FIG. 11 shows a flowchart that explains setting of a primary adjacent nozzle (primary adjacent dot) and a secondary adjacent nozzle (secondary adjacent dot) as a target of a correction process in the image forming apparatus 10 shown in FIGS. 1 to 4.

### DETAILED DESCRIPTION

Hereinafter, an embodiment according to an aspect of the present disclosure will be explained with reference to drawings.

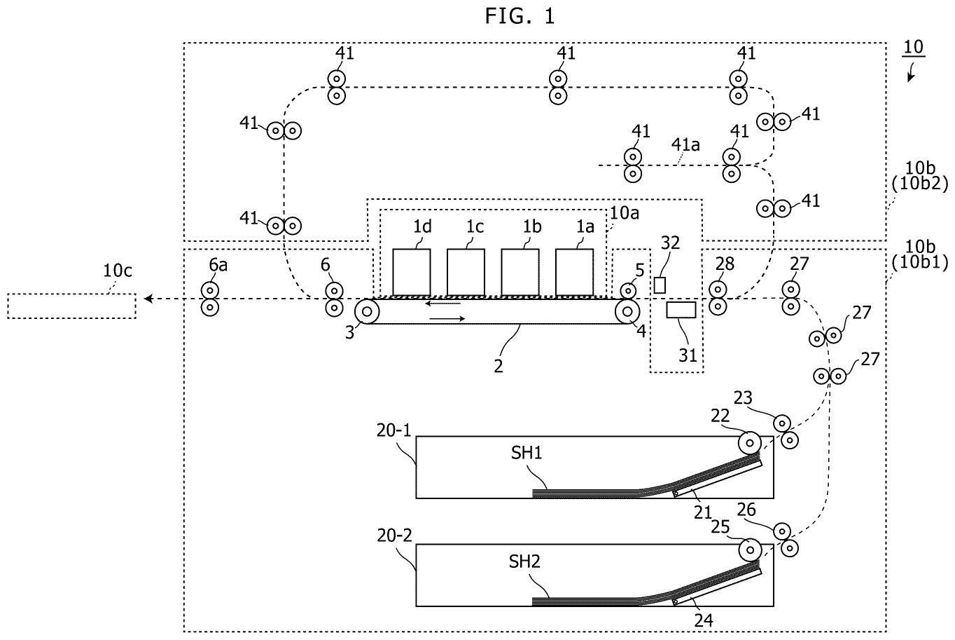

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type head units 1a to 1d corresponding to four ink colors: Cyan, Magenta, Yellow, and Black.

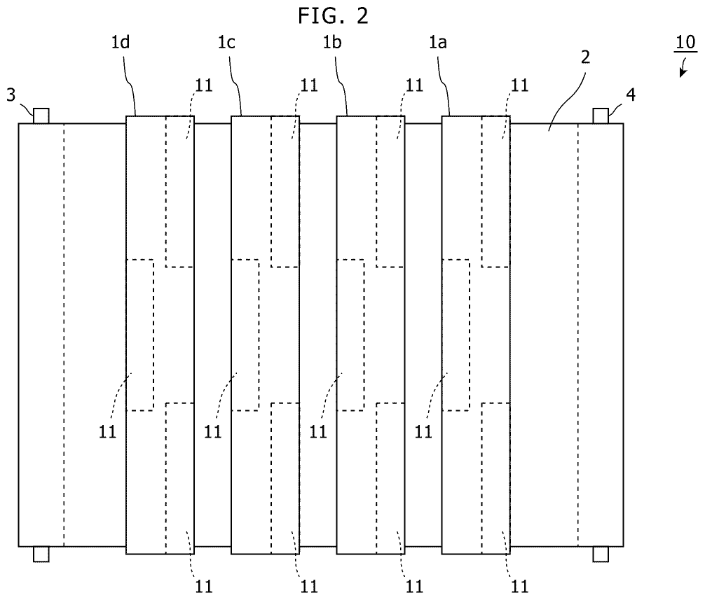

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11. The head unit 11 of the inkjet recording unit 1a, 1b, 1c or 1d includes 2-dimensionally arranged nozzles, and ejects ink corresponding to the image to be printed using the nozzles.

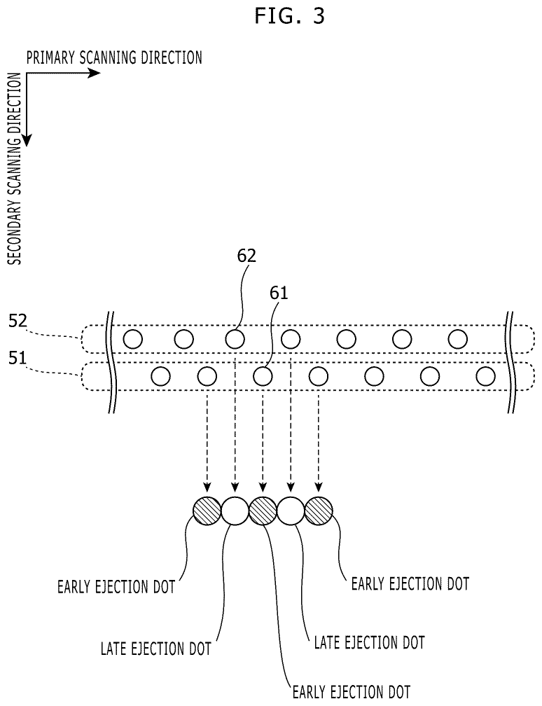

FIG. 3 shows a diagram that explains nozzles in the recording heads 1a to 1d shown in FIG. 2. For example, as shown in FIG. 3, the head unit 11 of each recording head 1a, 1b, 1c or 1d includes plural nozzle arrays 51 and 52. Here, each of the nozzle arrays 51 and 52 includes nozzles 61 or 62 arranged with a predetermined interval along a primary scanning direction. In a primary scanning direction, an offset is set to each of the plural nozzle arrays 51 and 52 such that the nozzles 61 and 62 are totally arranged with a constant interval; and in each of the nozzle arrays 51 and 52, the nozzles 61 or 62 are arranged with the offset.

When a certain position of a print sheet in a secondary scanning direction (i.e. transportation direction) passes at a position of a nozzle array 51, ink droplets are ejected from nozzles 61 of the nozzle array 51 (i.e. from early ejection nozzles); and afterward, when this position of the print sheet passes at a position of another nozzle array 52, ink droplets are ejected from nozzles 62 of the nozzle array 52 (i.e. from late ejection nozzles). Therefore, between dots formed with the early-ejected ink droplets (i.e. between early ejection dots), formed is a dot formed with the late-ejected ink droplet (late ejection dot).

Returning to FIG. 1, the sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

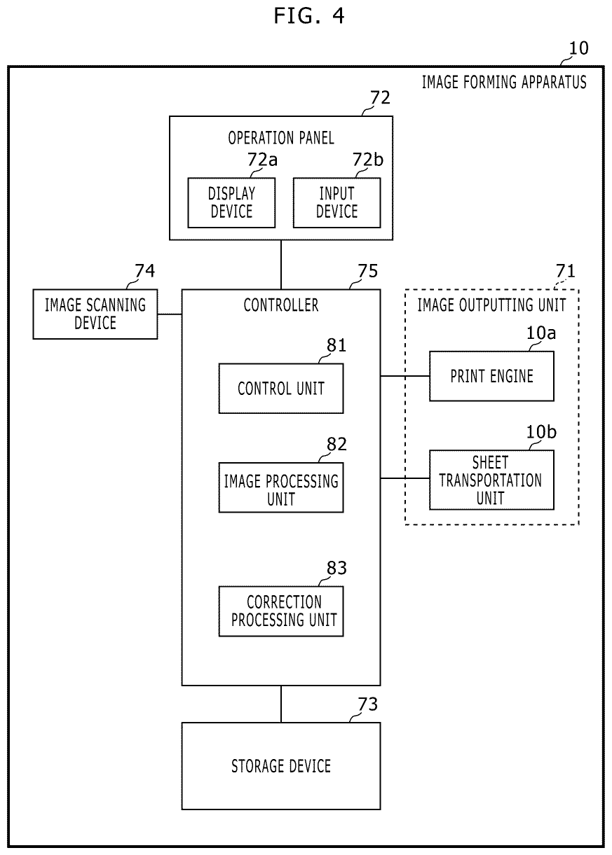

FIG. 4 shows a block diagram that indicates an electronic configuration of the image forming apparatus 10 in the embodiment according to the present disclosure. As shown in FIG. 4, the image forming apparatus 10 includes not only an image outputting unit 71 that includes the mechanical configuration shown in FIGS. 1 to 3 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, and a correction processing unit 83.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. The image processing unit 82 performs a predetermined image process such as RIP (Raster Image Processing), color conversion, halftoning and/or the like for image data of a printing image.

Specifically, the control unit 81 causes the print engine 10a to print a user document image based on printing image data specified by a user.

Further, in this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process.

Specifically, in the automatic centering function, the control unit 81 changes a depicting position of the image to be printed, in a primary scanning direction by a difference between a reference center position of the print engine 10a and the actual sheet center position. In this embodiment, because the nozzles 61 and 62 of the recording heads 1a to 1d do not move, a nozzle corresponding to each pixel in the image to be printed is changed correspondingly to the depicting position of the image to be printed.

As mentioned, the control unit 81 determines nozzles 61 and 62 corresponding to the image to be printed (a nozzle 61 or 62 corresponding to each pixel), correspondingly to a position of a print sheet, and causes the recording heads 1a to 1d to eject ink from the determined nozzles 61 and 62.

The correction processing unit 83 detects an ejection malfunction nozzle among the aforementioned nozzles 61 and 62, and performs a correction process corresponding to the ejection malfunction nozzle.

For example, using the control unit 81, the correction processing unit 83 prints a test pattern (one-dot thin lines respectively corresponding to the nozzles 61 and 62, a band along the primary scanning direction and/or the like) on a print sheet using the aforementioned recording heads 1a to 1d for each of the aforementioned plural ink colors, and determines an ejection malfunction nozzle and its ejection malfunction type (i.e. non ejection, ejection deviation and the like) on the basis of a scanned image of the test pattern. “Ejection deviation” means a state that deviation of a hitting position of an ink droplet ejected from a nozzle 61 or 62 occurs in the primary scanning direction.

The scanned image of the test pattern is acquired using the line sensor 31 or the image scanning device 74. If the line sensor 31 scans an image of the test pattern, the print sheet on which the test pattern has been printed by the print engine 10a is transported to a position of the line sensor 31 using the circulation transportation unit 10b2. Here, in accordance with an existent method, an ejection malfunction position is determined on the basis of a density distribution of the scanned image of the test pattern, and a nozzle 61 or 62 corresponding to the ejection malfunction position (i.e. a nozzle 11a that should eject ink at the ejection malfunction position) is determined as an ejection malfunction nozzle.

Further, for example, in the correction process, within time from determination of a sheet position to ink ejection, the processing 83 (a) determines a pixel corresponding to an ejection malfunction nozzle in an image to be printed, and (b) as mentioned below, performs density adjustment on a primary adjacent pixel (i.e. a pixel corresponding to a primary adjacent nozzle mentioned below) and a secondary adjacent pixel (i.e. a pixel corresponding to a secondary adjacent nozzle mentioned below).

Here, a primary adjacent nozzle and a secondary adjacent nozzle of the ejection malfunction nozzle are explained.

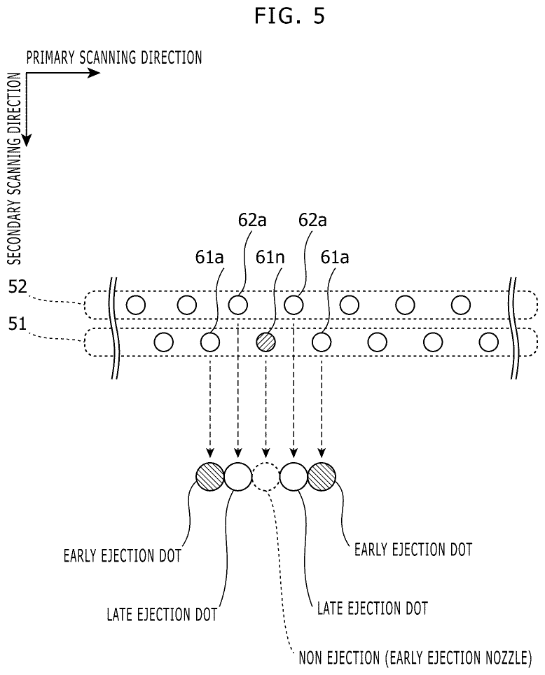

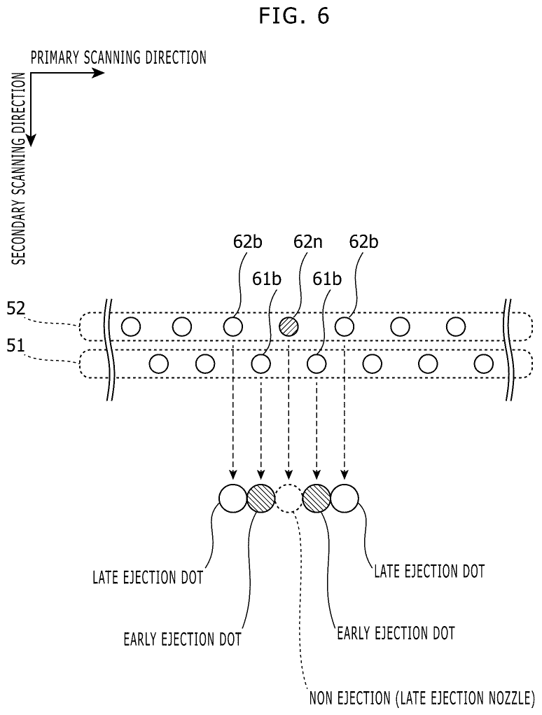

FIG. 5 shows a diagram that explains a primary adjacent nozzle and a secondary adjacent nozzle if an ejection malfunction nozzle is an early ejection nozzle. FIG. 6 shows a diagram that explains a primary adjacent nozzle and a secondary adjacent nozzle if an ejection malfunction nozzle is a late ejection nozzle.

The primary adjacent nozzle is a nozzle that ejects an ink droplet at a dot position adjacent to a dot position that the ejection malfunction nozzle should eject an ink droplet at, and the secondary adjacent nozzle is a nozzle that ejects an ink droplet at a dot position adjacent to a dot position that the primary adjacent nozzle should eject an ink droplet at. The ejection malfunction nozzle is not included in the secondary adjacent nozzle.

As shown in FIG. 5, if an ejection malfunction nozzle is an early ejection nozzle, then the primary adjacent nozzle 62a is a late ejection nozzle that should eject an ink droplet at a dot position adjacent to a dot position that the ejection malfunction nozzle 61n should eject ink at and the secondary adjacent nozzle 61a is an early ejection nozzle that should eject an ink droplet at a dot position adjacent to a dot position that the primary adjacent nozzle 62a should eject ink at.

As shown in FIG. 6, if an ejection malfunction nozzle is a late ejection nozzle, then the primary adjacent nozzle 61b is an early ejection nozzle that should eject an ink droplet at a dot position adjacent to a dot position that the ejection malfunction nozzle 62n should eject ink at and the secondary adjacent nozzle 62b is an early ejection nozzle that should eject an ink droplet at a dot position adjacent to a dot position that the primary adjacent nozzle 61b should eject ink at.

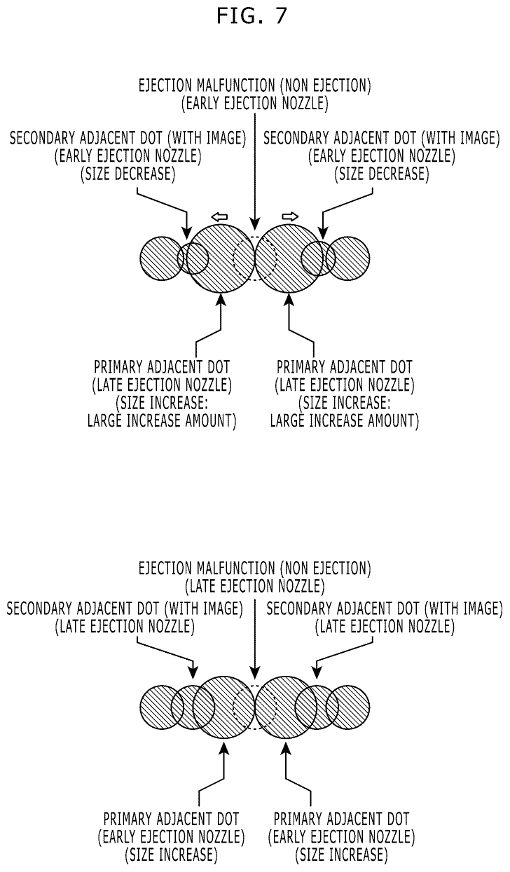

FIG. 7 shows a diagram that explains an ink ejection amount of a secondary adjacent nozzle in case of non ejection.

As shown in FIG. 7, the correction processing unit 83 (a) causes the secondary adjacent nozzle 62b to perform ink ejection with a first ink ejection amount if ink ejection of the primary adjacent nozzle 61b is performed earlier than ink ejection of the secondary adjacent nozzle 62b and (b) causes the secondary adjacent nozzle 61a to perform ink ejection with a second ink ejection amount if ink ejection of the primary adjacent nozzle 62a is performed later than ink ejection of the secondary adjacent nozzle 61b. Here the second ink ejection amount is set as a predetermined amount smaller than the first ink ejection amount.

Here, the correction processing unit 83 determines an ejection malfunction type (non ejection, ejection deviation or the like) of the ejection malfunction nozzle using an existent method; and if the ejection malfunction type is non ejection, an ink ejection amount of the primary adjacent nozzle 62a when ink ejection of the primary adjacent nozzle 62a is performed later than ink ejection of the secondary adjacent nozzle 61a is set as a predetermined amount larger than an ink ejection amount of the primary adjacent nozzle 61b when ink ejection of the primary adjacent nozzle 61b is performed earlier than ink ejection of the secondary adjacent nozzle 62b.

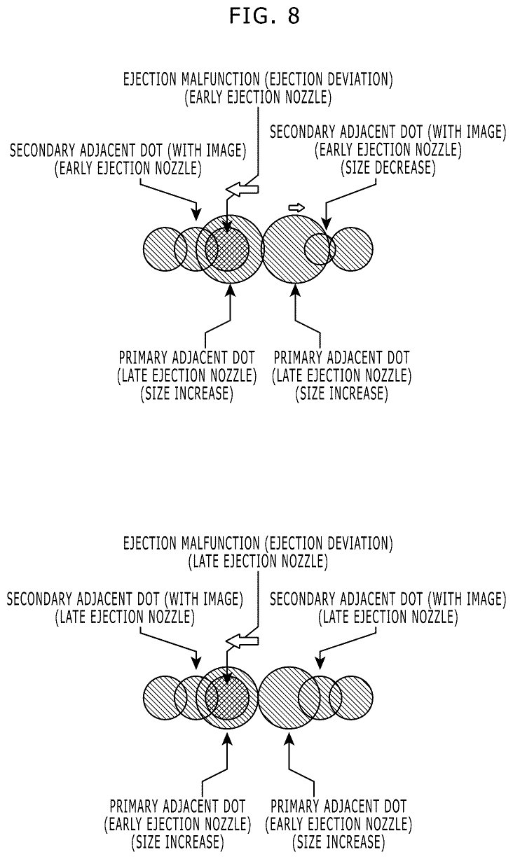

FIG. 8 shows a diagram that explains an ink ejection amount of a secondary adjacent nozzle in case of ejection deviation.

Further, if the aforementioned ejection malfunction type is ejection deviation and ink ejection of the primary adjacent nozzle 62a is performed later than ink ejection of the secondary adjacent nozzle 61a as shown in FIG. 8 for example, the correction processing unit 83 (a) causes the secondary adjacent nozzle 61a in a direction of ejection deviation to perform ink ejection with the aforementioned first ink ejection amount and (b) causes the secondary adjacent nozzle 61a in opposite to a direction of ejection deviation to perform ink ejection with the aforementioned second ink ejection amount.

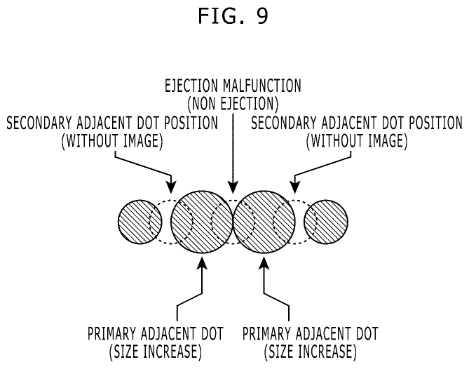

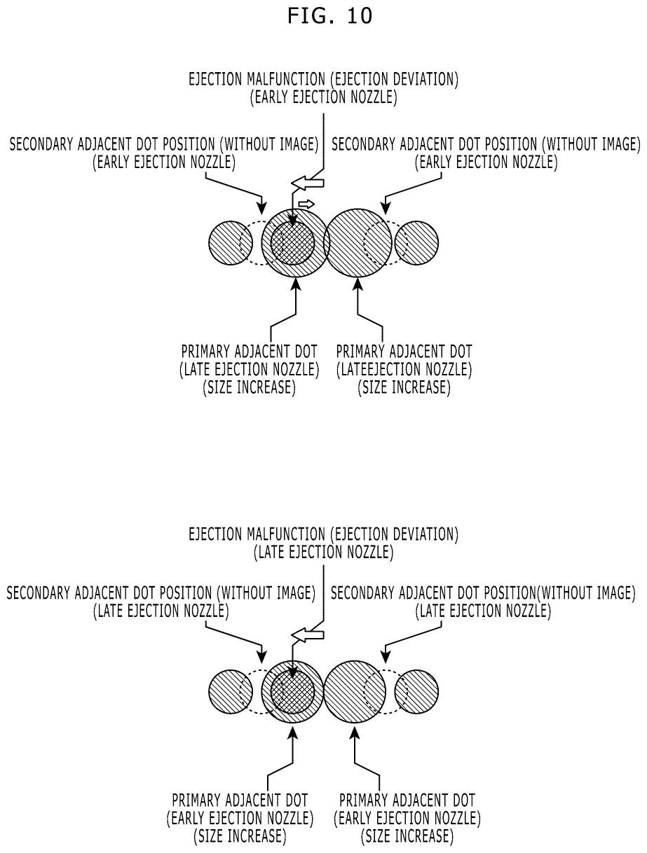

FIG. 9 shows a diagram that explains an ink ejection amount of a primary adjacent nozzle in case of non ejection. FIG. 10 shows a diagram that explains an ink ejection amount of a primary adjacent nozzle in case of ejection deviation.

Furthermore, the correction processing unit 83 determines whether the secondary adjacent nozzle should perform ink ejection or not; and if the secondary adjacent nozzle should not perform ink ejection as shown in FIGS. 9 and 10 for example, causes the primary adjacent nozzle to perform ink ejection with a constant ink ejection amount regardless of an ink ejection order of the primary adjacent nozzle and the secondary adjacent nozzle.

Furthermore, as shown in FIGS. 7 and 9, the correction processing unit 83 determines whether or not the secondary adjacent nozzle should perform ink ejection correspondingly to an image to be printed (i.e. existence of the image at the secondary adjacent dot position), and causes the primary adjacent nozzle to perform ink ejection with different ink ejection amounts in a case that the secondary adjacent nozzle performs ink ejection and a case that the secondary adjacent nozzle does not perform ink ejection. Specifically, an ink ejection amount of the primary adjacent nozzle in a case that the secondary adjacent nozzle performs ink ejection is set as a predetermined amount larger than an ink ejection amount of the primary adjacent nozzle in a case that the secondary adjacent nozzle does not perform ink ejection.

Furthermore, if the ejection malfunction type is ejection deviation, the secondary adjacent nozzle performs ink ejection and ink ejection of the primary adjacent nozzle 62a is performed later than ink ejection of the secondary adjacent nozzle 61a, then as shown in FIG. 8 for example, the correction processing unit 83 (a) causes the secondary adjacent nozzle 61a in a direction of ejection deviation to perform ink ejection with the first ink ejection amount and (b) causes the secondary adjacent nozzle 61a in opposite to a direction of ejection deviation to perform ink ejection with the second ink ejection amount that is smaller than the first ink ejection amount.

Furthermore, if ink ejection of the primary adjacent nozzle 62a is later than ink ejection of the secondary adjacent nozzle 61a, the correction processing unit 83 causes the primary adjacent nozzle 62a to perform ink ejection with an ink ejection amount corresponding to the ejection malfunction type of the ejection malfunction nozzle among different ink ejection amounts corresponding to ejection malfunction types of ejection malfunction nozzles. Specifically, an ink ejection amount of the primary adjacent nozzle 62a when the ejection malfunction type is non ejection is set as a predetermined amount larger than an ink ejection amount of the primary adjacent nozzle 62a when the ejection malfunction type is other than non ejection.

Furthermore, if the secondary adjacent nozzle should not perform ink ejection, the correction processing unit 83 causes the primary adjacent nozzle to perform ink ejection with a constant ink ejection amount regardless of an ink ejection order of the primary adjacent nozzle and the secondary adjacent nozzle.

The following part explains a behavior of the image forming apparatus 10.

### (a) Setting of a Target of the Correction Process

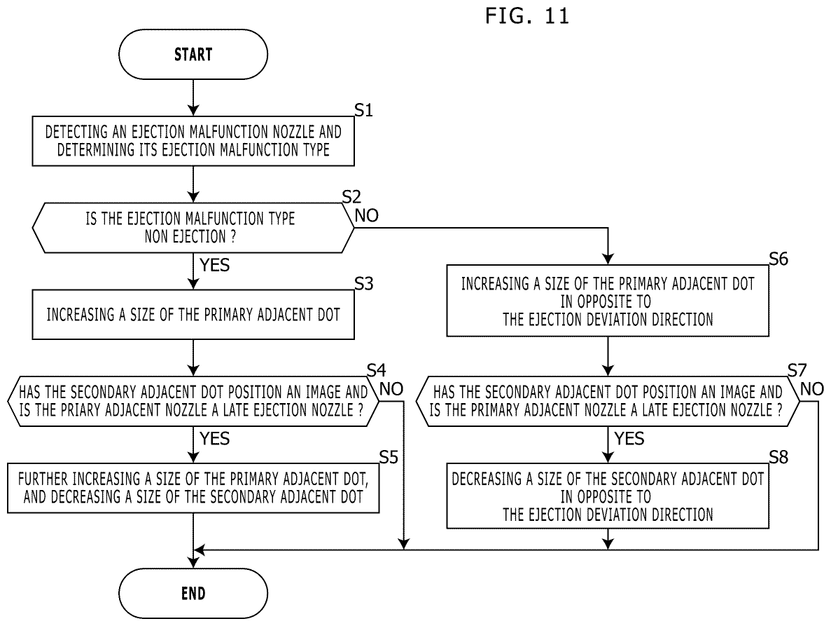

FIG. 11 shows a flowchart that explains setting of a primary adjacent nozzle (primary adjacent dot) and a secondary adjacent nozzle (secondary adjacent dot) as a target of a correction process in the image forming apparatus 10 shown in FIGS. 1 to 4.

The correction processing unit 83 detects a current ejection malfunction nozzle and determines an ejection malfunction type of the ejection malfunction nozzle (in Step S1). Specifically, using the control unit 81, the correction processing unit 83 causes the image outputting unit 71 to print to a print sheet a test pattern to determine an ejection malfunction nozzle. The correction processing unit 83 acquires a scanned image (i.e. image data of each ink color) of the test pattern using the line sensor 31 or the image scanning device 74 as mentioned. On the basis of a primary-scanning-directional density distribution of the scanned image of the test pattern, the correction processing unit 83 determines an ejection malfunction nozzle from an ejection malfunction position (a position that density defect occurs) in the density distribution and determines an ejection malfunction type of the ejection malfunction nozzle.

Subsequently, for each ejection malfunction nozzle, the correction processing unit 83 performs the following process.

The correction processing unit 83 determines whether the ejection malfunction type of the ejection malfunction nozzle is non ejection or not (in Step S2).

If the ejection malfunction type of the ejection malfunction nozzle is non ejection, then the correction processing unit 83 increases a setting value of a size of the primary adjacent dot (an ink ejection amount of the primary adjacent nozzle) from a default value (i.e. a value corresponding to a pixel value of a pixel corresponding to this dot (nozzle) in an image to be printed) to a first increased value (in Step S3).

In this case, subsequently, the correction processing unit 83 determines whether there is the image to be printed at the secondary adjacent dot position (i.e. the secondary adjacent nozzle performs ink ejection) and the primary adjacent nozzle is a late ejection nozzle or not (in Step S4).

If there is the image to be printed at the secondary adjacent dot position and the primary adjacent nozzle is a late ejection nozzle, then the correction processing unit 83 further increases the setting value of a size of the primary adjacent dot (an ink ejection amount of the primary adjacent nozzle) from the first increased value to a second increased value, and decreases a setting value of a size of the secondary adjacent dot (an ink ejection amount of the secondary adjacent nozzle) from a default value to a decreased value (in Step S5).

Contrarily, if there is not the image to be printed at the secondary adjacent dot position or the primary adjacent nozzle is an early ejection nozzle, then the setting value of a size of the primary adjacent dot (an ink ejection amount of the primary adjacent nozzle) is the first increased value, and the setting value of a size of the secondary adjacent dot (an ink ejection amount of the secondary adjacent nozzle) is the default value.

If the ejection malfunction type of the ejection malfunction nozzle is not non ejection (here, if the ejection malfunction type is ejection deviation), the correction processing unit 83 increases a setting value of a size of the primary adjacent dot (an ink ejection amount of the primary adjacent nozzle) in opposite to a direction to ejection deviation among the primary adjacent dots, from a default value to the first increased value (in Step S6). A setting value of a size of the primary adjacent dot (an ink ejection amount of the secondary adjacent nozzle) in a direction to ejection deviation is set as a default value.

In this case, subsequently, the correction processing unit 83 determines whether there is the image to be printed at the secondary adjacent dot position (i.e. the secondary adjacent nozzle performs ink ejection) and the primary adjacent nozzle is a late ejection nozzle or not (in Step S7).

If there is the image to be printed at the secondary adjacent dot position and the primary adjacent nozzle is a late ejection nozzle, then the correction processing unit 83 decreases the setting value of a size of the secondary adjacent dot (an ink ejection amount of the secondary adjacent nozzle) from a default value to a decreased value (in Step S8).

Contrarily, if there is not the image to be printed at the secondary adjacent dot position or the primary adjacent nozzle is an early ejection nozzle, then the setting value of a size of the secondary adjacent dot (an ink ejection amount of the secondary adjacent nozzle) is set as the default value.

Subsequently, the correction processing unit 83 stores into the storage device 73 ejection malfunction nozzle data that indicates the detected ejection malfunction nozzles as targets of the correction process and specifically indicates identification information of the ejection malfunction nozzles (nozzle numbers or the like) and the aforementioned setting values of the primary and secondary adjacent nozzles.

As mentioned, a target of the correction process is set for each ink ejection malfunction nozzle.

### (b) Behavior for Printing

When receiving a print request, the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this process, the correction processing unit 83 reads the ejection malfunction data from the storage device 73 prior to start of the printing, and determines ejection malfunction nozzles as targets of the correction process. Upon detecting a position of the print sheet by the line sensor 31, the correction processing unit 83 (a) determines a nozzle 61 or 62 corresponding to each pixel in the aforementioned image, and (b) determines an ejection malfunction nozzle among the nozzles 61 and 62 used for the aforementioned image and performs the correction process for each of the determined ejection malfunction nozzles. Consequently, the correction process is performed for a part (the aforementioned primary and/or secondary adjacent pixel positions) corresponding to the ejection nozzles as targets of the correction process. Subsequently, the control unit 81 performs the aforementioned printing on the basis of the image data after the correction process.

As mentioned, in the aforementioned embodiment, the correction processing unit 83 (a) causes the secondary adjacent nozzle to perform ink ejection with a first ink ejection amount if the primary adjacent nozzle is an early ejection nozzle and (b) causes the secondary adjacent nozzle to perform ink ejection with a second ink ejection amount that is smaller than the first ink ejection amount if the primary adjacent nozzle is a late ejection nozzle.

Consequently, movement due to coalescence of an ink droplet ejected from the primary adjacent nozzle of the ejection malfunction nozzle is properly controlled on the basis of a size of the secondary adjacent dot, and thereby the influence to image quality is restrained regardless of existence of a tertiary adjacent dot (a dot at a dot position adjacent to a dot position of the secondary adjacent dot in the primary scanning direction). Thus, it is restrained that image quality is affected by the adjustment of the ink ejection amounts to restrain influence of ejection malfunction on a nozzle.

Further, in the aforementioned embodiment, the correction processing unit 83 causes the primary adjacent nozzle to perform ink ejection with different ink ejection amounts in a case that the secondary adjacent nozzle performs ink ejection and a case that the secondary adjacent nozzle does not perform ink ejection.

Consequently, a dot size of the primary adjacent nozzle is properly adjusted in consideration of movement due to coalescence of an ink droplet ejected from the primary adjacent nozzle of the ejection malfunction nozzle, and therefore, the influence to image quality is restrained. Thus, it is restrained that image quality is affected by the adjustment of the ink ejection amounts to restrain influence of ejection malfunction of a nozzle.

Furthermore, in the aforementioned embodiment, if the primary adjacent nozzle is a late ejection nozzle, the correction processing unit 83 causes the primary adjacent nozzle to perform ink ejection with an ink ejection amount corresponding to the ejection malfunction type of the ejection malfunction nozzle among different ink ejection amounts corresponding to ejection malfunction types of ejection malfunction nozzles.

Consequently, a dot size of the primary adjacent nozzle is properly adjusted in consideration of movement due to coalescence of an ink droplet ejected from the primary adjacent nozzle of the ejection malfunction nozzle, and therefore, the influence to image quality is restrained. Thus, it is restrained that image quality is affected by the adjustment of the ink ejection amounts to restrain influence of ejection malfunction of a nozzle.

It should be understood that various changes and modifications to the embodiments described herein should be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink corresponding to an image to be printed, using nozzles;
a control unit configured to determine nozzles corresponding to the image to be printed, correspondingly to a position of a print sheet, and cause the recording head to eject ink from the nozzles;
a correction processing unit configured to detect an ejection malfunction nozzle and perform a correction process corresponding to the ejection malfunction nozzles;
wherein when a nozzle that ejects an ink droplet at a dot position adjacent to a dot position that the ejection malfunction nozzle should eject an ink droplet at is referred to as a primary adjacent nozzle and a nozzle that ejects an ink droplet at a dot position adjacent to a dot position that the primary adjacent nozzle should eject an ink droplet at is referred to as a secondary adjacent nozzle, the correction processing unit (a) causes the secondary adjacent nozzle to perform ink ejection with a first ink ejection amount if ink ejection of the primary adjacent nozzle is performed earlier than ink ejection of the secondary adjacent nozzle and (b) causes the secondary adjacent nozzle to perform ink ejection with a second ink ejection amount if ink ejection of the primary adjacent nozzle is performed later than ink ejection of the secondary adjacent nozzle; and
the second ink ejection amount is smaller than the first ink ejection amount.

2. The image forming apparatus according to claim 1, wherein the correction processing unit determines an ejection malfunction type of the ejection malfunction nozzle; and
if the ejection malfunction type is non ejection, an ink ejection amount of the primary adjacent nozzle when ink ejection of the primary adjacent nozzle is performed later than ink ejection of the secondary adjacent nozzle is larger than an ink ejection amount of the primary adjacent nozzle when ink ejection of the primary adjacent nozzle is performed earlier than ink ejection of the secondary adjacent nozzle.

3. The image forming apparatus according to claim 1, wherein the correction processing unit determines whether the secondary adjacent nozzle should perform ink ejection or not; and if the secondary adjacent nozzle should not perform ink ejection, causes the primary adjacent nozzle to perform ink ejection with a constant ink ejection amount regardless of an ink ejection order of the primary adjacent nozzle and the secondary adjacent nozzle.

4. The image forming apparatus according to claim 1, wherein the correction processing unit determines an ejection malfunction type of the ejection malfunction nozzle; and
if the ejection malfunction type is ejection deviation and ink ejection of the primary adjacent nozzle is performed later than ink ejection of the secondary adjacent nozzle, the correction processing unit (a) causes the secondary adjacent nozzle in a direction of ejection deviation to perform ink ejection with the first ink ejection amount and (b) causes the secondary adjacent nozzle in opposite to a direction of ejection deviation to perform ink ejection with the second ink ejection amount.
